(19) United States
(12) Patent Application Publication
(10) Pub. No.: US 2026/0037246 A1
(43) Pub. Date: Feb. 5, 2026

(54) AUTOMATICALLY UPDATING SOFTWARE COMPONENTS

(71) Applicant: Dell Products L.P., Round Rock, TX (US)

(72) Inventors: Shi Kai Khiew, Singapore (SG); Robin Kedia, Singapore (SG); Antony Prabakaran Jayaveeran, Singapore (SG); Hao Yu Feng, Singapore (SG); Sneha Vijay, Singapore (SG)

(21) Appl. No.: 18/794,332

(22) Filed: Aug. 5, 2024

(51) Int. Cl. G06F 8/65; G06F 21/57

(52) U.S. Cl. CPC G06F 8/65; G06F 21/577; G06F 2221/033

(57) ABSTRACT

Methods, apparatus, and processor-readable storage media for automatically updating software components are provided herein. An example computer-implemented method includes identifying, by at least one processing device of a computing platform, a release of an updated version of a software component of a software project and obtaining one or more of vulnerability information for the software component and license information associated with the software component. The method includes generating an upgrade score for the software component based on at least a portion of one or more of the obtained vulnerability information and the obtained license information and determining, by the at least one processing device, whether to upgrade the component to the updated version based at least in part on the upgrade score. The method also includes initiating one or more automated actions based at least in part on a result of the determining.

### BACKGROUND

Maintaining a secure software development lifecycle often depends on the ability to manage and update a software project in a timely manner. However, software projects often rely on multiple software components, that may include software dependencies, for example. It can be challenging to assess each software component to determine if an updated version is available and whether to update to the updated version.

### SUMMARY

Illustrative embodiments of the disclosure provide techniques for automatically updating software components. An exemplary computer-implemented method includes identifying, by at least one processing device of a computing platform, a release of an updated version of at least one software component of a software project and obtaining one or more of: vulnerability information for the at least one software component and license information associated with the at least one software component. The method includes generating an upgrade score for the at least one software component based on at least a portion of one or more of the obtained vulnerability information and the obtained license information. The method also includes determining, by the at least one processing device, whether to upgrade the at least one software component to the updated version based at least in part on the upgrade score and initiating one or more automated actions based at least in part on a result of the determining.

Illustrative embodiments can provide significant advantages relative to conventional techniques. For example, technical problems associated with ensuring security and compliance of software components are mitigated in one or more embodiments by implementing a process that upgrades components in software packages based on vulnerability and/or compliance statistics maintained for different versions of those software components.

These and other illustrative embodiments described herein include, without limitation, methods, apparatus, systems and computer program products comprising processor-readable storage media.

### BRIEF DESCRIPTION OF THE DRAWINGS

FIG. 1 shows an information processing system configured for automatically updating software components in an illustrative embodiment.

FIG. 2 shows a system diagram of an update management system in an illustrative embodiment.

FIG. 3 shows a flow diagram of a process for analyzing software packages in an illustrative embodiment.

FIG. 4 shows a flow diagram of a process for computing an upgrade score in an illustrative embodiment.

FIG. 5 shows a flow diagram of a process for automatically updating software components in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Conventional techniques for updating software components within a software project, and understanding the security impact of such updates, are often inefficient because they frequently rely on multiple different scan tools and manually generated release reports for various releases of the software project. For example, a given developer may have to gather data from different scan tools (e.g., by manually visiting different websites or accessing different applications) to identify and understand the results. The results are then manually consolidated for security review. Furthermore, a list of software components (e.g., a software bill of materials (SBOM)) and licenses used in the software project is created. This typically occurs close to the release date, which makes it challenging to resolve any compliance issues before the release. Moreover, determining whether or not a given software component should be updated often involves identifying each software component in the software project and manually searching for the latest version available, followed by determining whether or not the upgrade should be performed. Conventional techniques also do not provide mechanisms for automatically updating software components.

One or more embodiments described herein provide a centralized management tool that can determine if updated versions of software components are available, and then compute an upgrade score to determine whether or not a given one of the software components should be updated. Some embodiments can effectively improve the functionality, stability and/or security of the software by, for instance, automatically determining which software components should be updated to the latest versions and which software components should not be updated (such as components that have a high probability of introducing vulnerabilities and/or crashes). Additionally, some embodiments provide an interactive dashboard that can display relevant information (e.g., version information, vulnerability statistics and/or recommendations) for each of the software components across different manifests of a project. This can provide an overview of the releases and overall security posture of the project.

It is to be appreciated that the term “software component” in this context and elsewhere herein is intended to be broadly construed so as to encompass, for example, a unit of software within a larger software system or project that can be independently identified and updated. Such a software component can correspond to one or more libraries, one or more frameworks, one or more software modules, one or more plugins and/or one or more applications, as non-limiting examples.

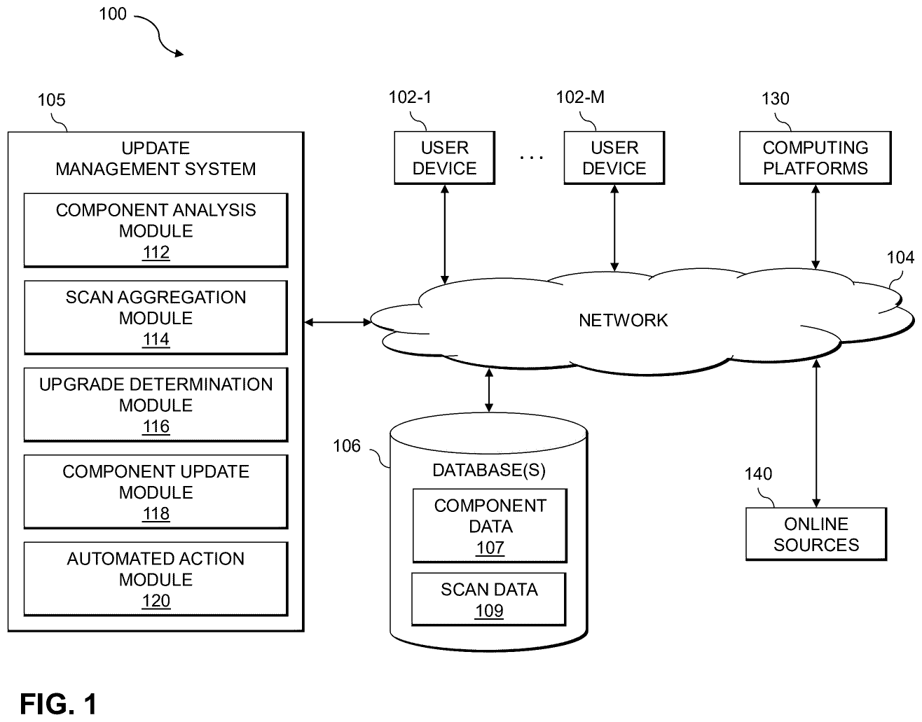

FIG. 1 shows a computer network (also referred to herein as an information processing system) 100 configured in accordance with an illustrative embodiment. The computer network 100 comprises a plurality of user devices 102-1, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is an update management system 105, one or more computing platforms 130 and one or more online sources 140.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the update management system 105 can have at least one associated database 106 configured to store data pertaining to, for example, component data 107 and/or scan data 109. For example, the component data 107 can include information related to one or more versions of software components in a software project. In some embodiments, the version information can include release notes, issue tracking information, identifiers and release dates of the one or more versions of a given software component in the software project. In some embodiments, the scan data 109 includes vulnerability information related to results of scans for the software components. For example, the vulnerability information can indicate categories and/or types of vulnerabilities identified in a given software component and a respective number of vulnerabilities in each category and/or type.

An example database 106, such as depicted in the present embodiment, can be implemented using one or more storage systems associated with the update management system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the update management system 105 are one or more input-output devices, which illustratively comprise keyboards, displays or other types of input-output devices in any combination. Such input-output devices can be used, for example, to support one or more user interfaces to the update management system 105, as well as to support communication between update management system 105 and other related systems and devices not explicitly shown.

Additionally, the update management system 105 in the FIG. 1 embodiment is assumed to be implemented using at least one processing device. Each such processing device generally comprises at least one processor and an associated memory, and implements one or more functional modules for controlling certain features of the update management system 105.

More particularly, the update management system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the update management system 105 to communicate over the network 104 with the user devices 102, and illustratively comprises one or more conventional transceivers.

The update management system 105 further comprises a component analysis module 112, a scan aggregation module 114, an upgrade determination module 116, a component update module 118 and an automated action module 120.

In some embodiments, the component analysis module 112 analyzes information related to software components in one or more software projects. For example, the component analysis module 112 can analyze the component data 107 to determine which software components are present in a software project and what versions of those components are currently being used. The component analysis module 112 can also determine whether updated versions of any software component in the software project are available by periodically obtaining information from one or more online sources 140. Alternatively or additionally, the component analysis module 112 can search forums and/or issue tracking systems for information related to the software components, as described in more detail elsewhere herein.

Generally, the scan aggregation module 114 aggregates results of scans performed by one or more vulnerability scan tools and stores the results in the one or more databases 106 (e.g., as scan data 109). Accordingly, the scan aggregation module 114 enables, for example, results from multiple different scanning tools, possibly executing on various computing platforms (e.g., computing platforms 130), to be collected and stored in a centralized location for analysis.

In response to determining that an updated version of at least one software component in the software project has been released, the upgrade determination module 116 generates a corresponding upgrade score. In some embodiments, the upgrade determination module 116 generates the upgrade score by processing the information obtained by the component analysis module 112 and the results aggregated by the scan aggregation module 114.

In some embodiments, the upgrade determination module 116 can trigger the component update module 118 to update the software project with the latest version of the component based at least in part on the generated score.

The automated action module 120 can perform one or more automated actions based on the generated upgrade score for the at least one software component. For example, the software project can be automatically deployed to one or more of the computing platforms 130, based at least in part on the generated score. Alternatively or additionally, one or more tests (e.g., unit and/or integration software tests) can be performed on the at least one software component. The results of the test can then be used to further adjust the upgrade score (e.g., by the upgrade determination module 116). In at least one embodiment, the automated action module 120 can provide the generated upgrade score and possibly other information related to the software components to an interactive dashboard that is accessible by the user devices 102, thereby enabling users to review and/or approve updates of software components, for example.

It is to be appreciated that this particular arrangement of elements 112, 114, 116, 118 and 120 illustrated in the update management system 105 of the FIG. 1 embodiment is presented by way of example only, and alternative arrangements can be used in other embodiments. For example, the functionality associated with the elements 112, 114, 116, 118 and 120 in other embodiments can be combined into a single module, or separated across a larger number of modules. As another example, multiple distinct processors can be used to implement different ones of the elements 112, 114, 116, 118 and 120 or portions thereof.

At least portions of elements 112, 114, 116, 118 and 120 may be implemented at least in part in the form of software that is stored in memory and executed by a processor.

It is to be understood that the particular set of elements shown in FIG. 1 for update management system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the update management system 105, the databases 106 and/or the computing platforms 130 can be on and/or part of the same processing platform.

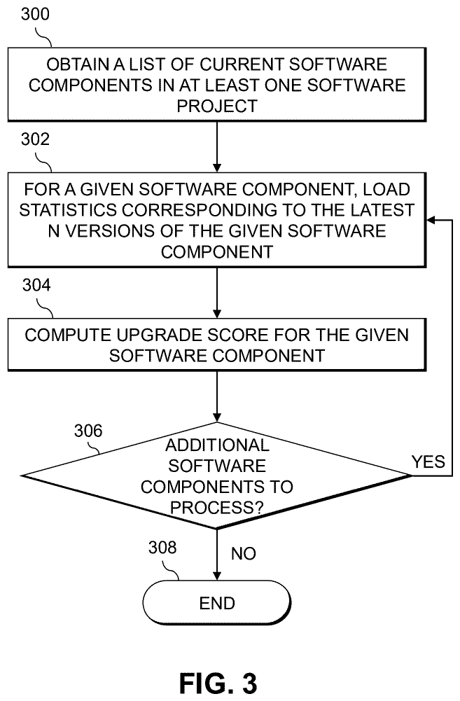

An exemplary process utilizing elements 112, 114, 116, 118 and 120 of an example update management system 105 in computer network 100 will be described in more detail with reference to, for example, the flow diagrams of FIGS. 3-5.

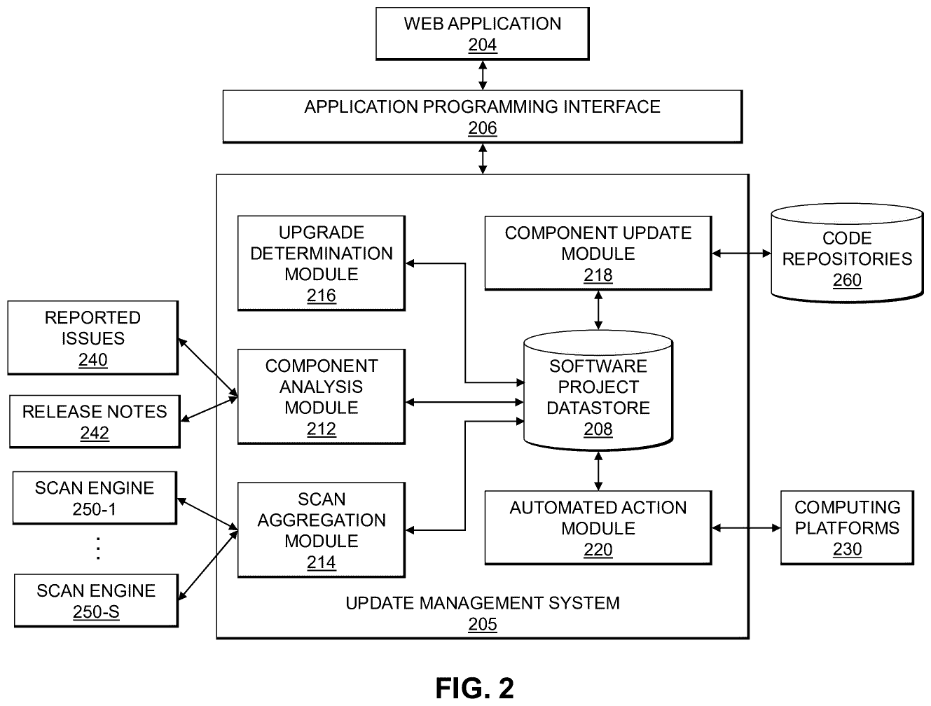

FIG. 2 shows a system diagram of an update management system 205 in an illustrative embodiment. Similar to FIG. 1, the update management system 205 depicted in FIG. 2 includes a component analysis module 212, a scan aggregation module 214, an upgrade determination module 216, a component update module 218, an automated action module 220 and a software project datastore 208. In this example, a web application 204 is used for communicating with the update management system 205 via an application programming interface (API) 206.

In this example, the component analysis module 212 obtains information related to reported issues 240 and/or release notes 242 for one or more versions of software components in a software project. The component analysis module 212 can analyze the information related to the reported issues 240 to determine whether the one or more versions introduce any changes that would negatively impact the software project, if an update is performed. The information related to the reported issues 240 can be obtained from various online sources, such as code management systems, forums, blogs, or other sources that include information related to the software components. Alternatively or additionally, the component analysis module 212 can analyze the release notes 242 to determine if any code changes in the one or more versions of a given software component could impact the functionality of the software component when upgrading from one of the previous versions. The information related to the reported issues 240 and/or the release notes 242 can be stored in the software project datastore 208. The component analysis module 212 can also store data related to the types of software licenses corresponding to the software components (e.g., open-source licenses, proprietary licenses, etc.).

The scan aggregation module 214 obtains results from a plurality of scan engines 250-1, . . . 250-S (collectively, scan engines 250). In some embodiments, the scan engines 250 can comprise various types of scan engines. For example, the scan engines 250 can include scan engines configured for different programming languages, scan engines configured for different types of applications or infrastructure (e.g., cloud-native applications, desktop applications, mobile applications, etc.), scan engines that utilize different scanning or testing methodologies (e.g., static application security testing, dynamic application security testing, interactive application security testing and/or software composition testing) and/or other types of scan engines configured to identify security issues. The aggregated scan results can be stored in the software project datastore 208. Consequently, the software project datastore 208 provides a centralized datastore that tracks reported issues 240, release notes 242, license information and security findings for different versions of each component in the software project.

Although the scan engines 250 in the FIG. 2 example are shown separate from the update management system 205, it is to be appreciated that, in other embodiments, at least a portion of the scan engines 250 can be implemented by the update management system 205.

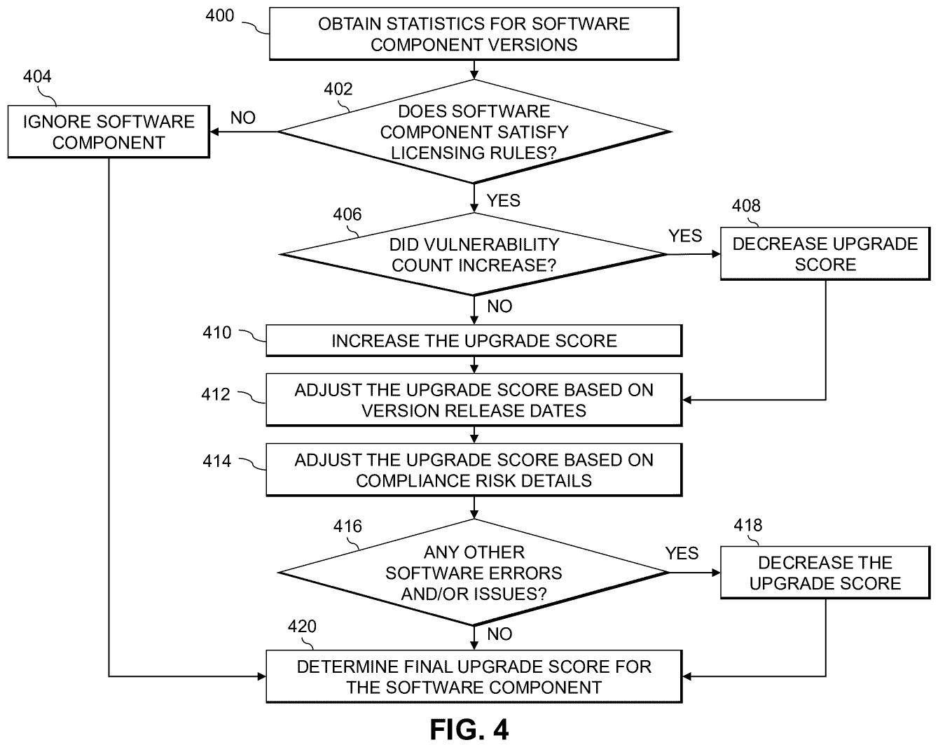

In response to an updated version of a software component being released, the upgrade determination module 216 can generate an upgrade score by analyzing the information stored in the software project datastore 208 for that software component, as discussed in more detail in conjunction with FIGS. 3 and 4, for example. The upgrade score generally indicates whether the corresponding software component should be upgraded to the updated version. Upgrade scores generated by the upgrade determination module 216 can also be stored in the software project datastore 208.

The component update module 218 is configured, in some embodiments, to update software components in the software project based at least in part on the upgrade scores generated by the upgrade determination module 216. As a non-limiting example, if the upgrade score for an updated version of a given software component satisfies a designated threshold value, then the upgrade determination module 216 can retrieve the updated version from one or more code repositories 260 and upgrade the software component to the updated version. It is noted that the one or more code repositories 260 may include one or more local code repositories (e.g., for storing source code developed by an organization corresponding to the software project) and/or public code repositories (e.g., for source code associated with open-source software components). The component update module 218 can alternatively or additionally update a given software component following additional validation (e.g., automated testing and/or verification by one or more users).

In some embodiments, the automated action module 220 can perform various automated actions based on information in the software project datastore 208. For example, in some embodiments, the automated action module 220 can trigger an automated test pipeline to test an updated version of a software component. The automated test pipeline can include, for example, unit and/or integration testing. The results of the automated test pipeline can then be used to further adjust the upgrade score of the software component. Additionally, in some embodiments, the automated action module 220 can be configured to automatically deploy updated versions of one or more software components to one or more computing platforms 230.

In some embodiments, the automated action module 220 can be configured to update an interactive dashboard (e.g., associated with the web application 204), which provides a centralized source for viewing information related to upgrading software components. For example, the interactive dashboard can display information related to licenses, vulnerabilities and/or software component versions across different releases of a software project. The interactive dashboard can display the generated upgrade scores for different components and request user verification before upgrading one or more of the software components, for example.

FIG. 3 shows a flow diagram of a process for analyzing software packages in an illustrative embodiment. It is to be understood that this particular process is only an example, and additional or alternative processes can be carried out in other embodiments.

In this embodiment, the process includes steps 300 through 308. These steps are assumed to be performed by the update management system 105 and/or 205.

Step 300 includes obtaining a list of current software components in at least one software project. For example, the list of current software components can include current versions of software components that are used in at least one software project.

Step 302 includes, for a given software component, loading statistics corresponding to the latest N versions of the given software component. As non-limiting examples, the statistics can correspond to compliance risk details (e.g., license information, misconfiguration issues detected by one or more security scanners and/or implementation violations against industry standards); code vulnerabilities and vulnerability severity ratings; release dates of each version; and/or stability indicators extracted from release notes, forums and/or issue tracking systems.

Step 304 includes computing an upgrade score for the given software component. An example of a process for computing the upgrade score is described in more detail in conjunction with FIG. 4.

Step 306 includes a test to check whether there are additional software components to process. If the result of step 306 is yes, then the process returns to step 302 to process the additional software component. The process ends at step 308 when all software components in the software project have been processed.

FIG. 4 shows a flow diagram of a process for computing an upgrade score in an illustrative embodiment. It is to be understood that this particular process is only an example, and additional or alternative processes can be carried out in other embodiments. The process can correspond to step 304 of FIG. 3, for example. It is assumed that a new version of a software component of a software project has been released, and that the system (e.g., the update management system 105 and/or 205) has tracked statistics for one or more previous versions of the software component.

Step 400 includes obtaining the statistics for the software component versions. As noted above, the statistics can correspond to vulnerabilities, compliance risk details and stability indicators, for example.

Step 402 includes a test to determine whether the software component satisfies one or more licensing rules. In some embodiments, the licensing rules can be defined by an organization developing or implementing the software project. For example, an organization may specify one or more licensing rules, such as a licensing rule that only open-source licenses are allowed or licensing rules defining other licensing criteria. In such an example, a software license associated with the software component can be retrieved from various sources, such as the source code, release notes and/or online documentation. The retrieved software license is then compared to the one or more licensing rules. If the retrieved software license is an open-source license, then the corresponding licensing rule is satisfied.

If the result of step 402 is no, then the process continues to step 404, which includes ignoring the software component. In some embodiments, ignoring the software component can include setting the upgrade score to a designated value (e.g., zero) to indicate that the component should not be upgraded until the licensing rules are changed or the license for the software component is changed, for example. The process then continues to step 420, which includes determining the final upgrade score for the software component. If the result of step 402 is yes, then the process continues to step 406.

Step 406 includes a test that checks whether a vulnerability count has increased. The vulnerability count may be specified, for example, in the statistics obtained in step 400. If the result of step 406 is yes, then the process continues to step 408, which decreases the upgrade score for the software component. The process then continues to step 412.

If the result of step 406 is no, then the process continues to step 410, which increases the upgrade score for the software component.

In some embodiments, step 406 can be performed for different severity categories of vulnerabilities. For example, step 406 can first be performed to check whether the number of critical vulnerabilities increased or decreased, and then check whether the number of high severity vulnerabilities increased or decreased, followed by medium severity and low severity vulnerabilities, for example. In such embodiments, the upgrade score can be adjusted relative to the severity category.

Step 412 includes adjusting the upgrade score based on version release dates. For example, a designated waiting period can be specified before updating a software component to a new version to determine if any issues with the updated version are identified. If the time from when the new version was released is less than the designated waiting period, then the upgrade score remains unchanged. Following the designated waiting period, the upgrade score can be increased based on the release date of the current version being used and the release date of the updated version. For example, the upgrade score can be increased based on the number of months between the release dates.

Step 414 includes adjusting the upgrade score based on compliance risk details. For example, misconfiguration issues and/or implementation violations present in the updated version will decrease the upgrade score.

Step 416 includes a test that checks whether there are any other software errors and/or issues. Such errors and/or issues can correspond to the stability indicators extracted from release notes, forums and/or issue tracking systems for the versions. If the result of step 416 is no, then the process continues to step 420, which includes determining the final upgrade score for the software component.

If the result of step 416 is yes, then step 418 is performed. Step 418 includes decreasing the upgrade score. For example, if release notes indicate one or more changes will negatively impact the software project, then the score can be decreased by the number of such changes. Alternatively or additionally, the upgrade score can be decreased at step 418 based on the number of issues identified in issue tracking systems, forums, or blogs, for example. The final upgrade score is then determined at step 420.

In some embodiments, an upgrade score for a software component can be calculated based on a set of designated metrics and a corresponding set of weights between at least two versions of the software component. As a non-limiting example, the set of metrics can comprise information related to: (i) counts for one or more categories of vulnerabilities (e.g., critical, high, medium and/or low); (ii) release dates of the versions; (iii) compliance risk details (e.g., misconfiguration alerts); and/or (iv) published issues associated with the latest version. The published issues, in some embodiments, can be related to code, performance and/or features of the latest version that are published in issue tracking systems, forums and/or other online sources. Each metric can be assigned a corresponding weight (e.g., 25%). Various other weighting schemes are possible depending on the implementation. For example, the counts for the one or more categories of vulnerabilities can be assigned a weight of 40%, and each of the other metrics in the set can be assigned a weight of 20%.

In some embodiments, the upgrade score can be normalized to be within a designated range (e.g., a range of 1-100). As a non-limiting example, each type of vulnerability count of the updated version can be compared with the current version, and then the upgrade score can be adjusted as follows: if the critical vulnerability count is reduced, then the upgrade score can be increased by 25, and if the critical vulnerability count is increased the upgrade score can be decreased by 25. The upgrade score can then be reduced or increased by designated values for each of the other vulnerability categories (e.g., by 15, 10 and 5 for high, medium and low, respectively).

For the version release dates, the upgrade score can be adjusted as follows: if the difference between the version release dates is less than three months, then the upgrade score can be increased by 5; if the difference between the version release dates is between 3 months to 6 months, then the upgrade score can be increased by 10; if the difference between the version release dates is between 6 months to a year, then the upgrade score can be increased by 15; and if the difference between the version release dates is more than a year, then the upgrade score can be increased by 25.

For compliance risk details, the upgrade score can be increased by 25 if one or more misconfiguration alerts (e.g., sensitive information or secrets) are identified in the code of the software component, then the score can be decreased by 25, otherwise the score can be increased by 25. If one or more published issues categorized as high or critical are identified in the latest version, then the upgrade score can be reduced by 25. If one or more published issues categorized as medium or low are identified in the latest version, then the upgrade score can be reduced by 10. If no published issues are identified, then there can be no change to the upgrade score.

Once the upgrade score is computed for the latest version of the component, it can be compared to a set of score ranges, where each score range triggers one or more automated actions, for example.

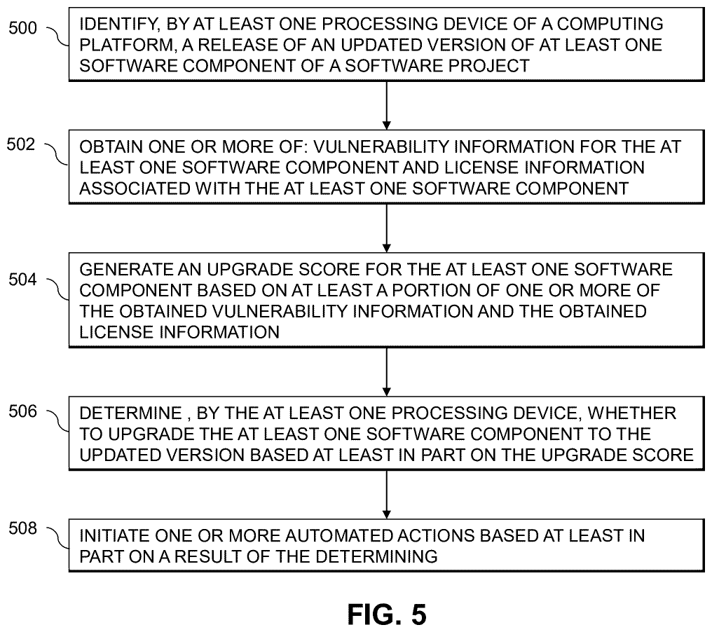

FIG. 5 is a flow diagram of a process for automatically updating software components in an illustrative embodiment. It is to be understood that this particular process is only an example, and additional or alternative processes can be carried out in other embodiments.

In this embodiment, the process includes steps 500 through 508. These steps are assumed to be performed by the update management system 105 utilizing its elements 112, 114, 116, 118, and 120.

Step 500 includes identifying, by at least one processing device of a computing platform, a release of an updated version of at least one software component of a software project.

Step 502 includes obtaining one or more of: vulnerability information for the at least one software component and license information associated with the at least one software component.

Step 504 includes generating an upgrade score for the at least one software component based on at least a portion of one or more of the obtained vulnerability information and the obtained license information.

Step 506 includes determining, by the at least one processing device, whether to upgrade the at least one software component to the updated version based at least in part on the upgrade score.

Step 508 includes initiating one or more automated actions based at least in part on a result of the determining.

In some embodiments, a plurality of security scanners may generate the vulnerability information. The plurality of security scanners may include at least two distinct security scanner tools operating on separate processing platforms.

The one or more automated actions may include at least one of updating the at least one software component to the updated version, deploying the updated version of the at least one software component to one or more computing environments, and providing the upgrade score and information related to the at least one software component to an interactive dashboard.

The vulnerability information may be obtained for a plurality of versions of the at least one software component and comprises a respective vulnerability count for each of two or more vulnerability severity levels.

The generating the upgrade score may include comparing the vulnerability information across multiple previous versions of the at least one software component.

The upgrade score may be further based on version information obtained from one or more online sources. The version information may include release dates corresponding to respective ones of the plurality of versions of the at least one software component, release notes corresponding to respective ones of the plurality of versions of the at least one software component, and issue tracking information corresponding to respective ones of the plurality of versions of the at least one software component.

The process may further include the steps of performing one or more of unit testing and integration testing for the updated version of the at least one software component and adjusting the upgrade score based at least in part on a result of the one or more of the unit testing and the integration testing.

The generating the upgrade score may include comparing the license information to one or more license criteria maintained by an organization associated with the software project.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly improve security and regulatory compliance by automatically updating components in software packages based on vulnerability and/or compliance statistics maintained for different versions of the software components. These and other embodiments can efficiently upgrade software components while avoiding potential vulnerabilities and/or errors resulting from updated versions of such software components.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

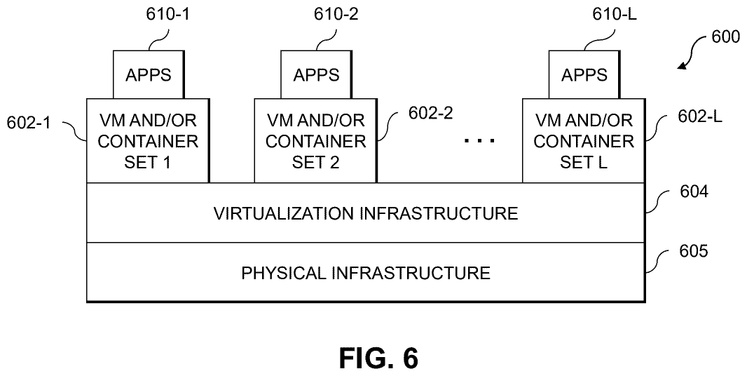

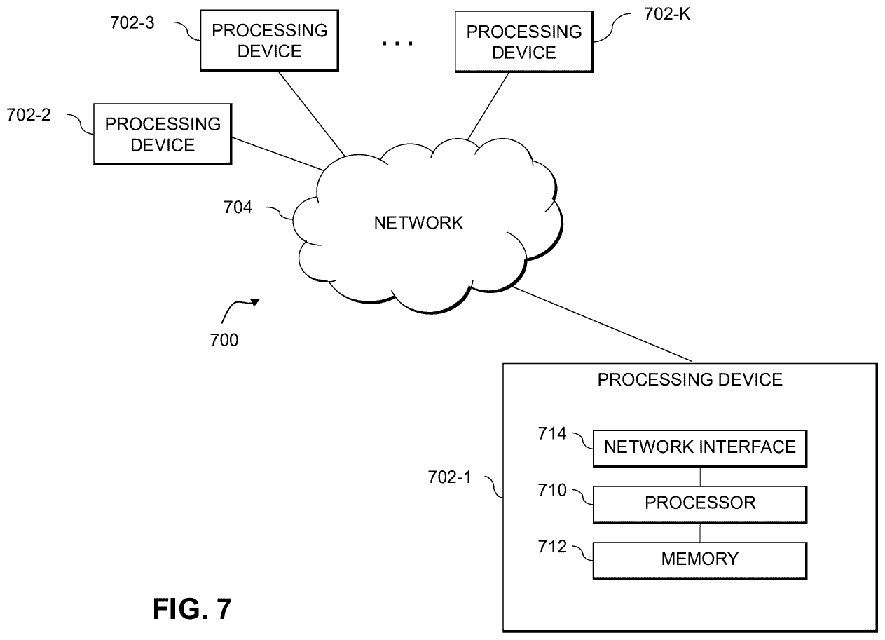

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a microcontroller, an ASIC, an FPGA or other type of processing circuitry, as well as portions or combinations of such circuitry elements.

The memory 712 comprises RAM, ROM or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
identifying, by at least one processing device of a computing platform, a release of an updated version of at least one software component of a software project;
obtaining one or more of: vulnerability information for the at least one software component and license information associated with the at least one software component;
generating an upgrade score for the at least one software component based on at least a portion of one or more of the obtained vulnerability information and the obtained license information;
determining, by the at least one processing device, whether to upgrade the at least one software component to the updated version based at least in part on the upgrade score; and
initiating one or more automated actions based at least in part on a result of the determining;
wherein the method is performed by the at least one processing device comprising a processor coupled to a memory.

2. The computer-implemented method of claim 1, wherein a plurality of security scanners generates the vulnerability information and wherein the plurality of security scanners comprises at least two distinct security scanner tools operating on separate processing platforms.

3. The computer-implemented method of claim 1, wherein the one or more automated actions comprise at least one of:
updating the at least one software component to the updated version;
deploying the updated version of the at least one software component to one or more computing environments; and
providing the upgrade score and information related to the at least one software component to an interactive dashboard.

4. The computer-implemented method of claim 1, wherein the vulnerability information is obtained for a plurality of versions of the at least one software component and comprises a respective vulnerability count for each of two or more vulnerability severity levels.

5. The computer-implemented method of claim 4, wherein the generating the upgrade score comprises comparing the vulnerability information across multiple previous versions of the at least one software component.

6. The computer-implemented method of claim 4, wherein the upgrade score is further based on version information obtained from one or more online sources, wherein the version information comprises:
release dates corresponding to respective ones of the plurality of versions of the at least one software component;
release notes corresponding to respective ones of the plurality of versions of the at least one software component; and
issue tracking information corresponding to respective ones of the plurality of versions of the at least one software component.

7. The computer-implemented method of claim 1, further comprising:
performing one or more of unit testing and integration testing for the updated version of the at least one software component; and
adjusting the upgrade score based at least in part on a result of the one or more of the unit testing and the integration testing.

8. The computer-implemented method of claim 1, wherein the generating the upgrade score comprises comparing the license information to one or more license criteria maintained by an organization associated with the software project.

9. A non-transitory processor-readable storage medium having stored therein program code of one or more software programs, wherein the program code when executed by at least one processing device causes the at least one processing device:
to identify, by the at least one processing device, a release of an updated version of at least one software component of a software project;
to obtain one or more of: vulnerability information for the at least one software component and license information associated with the at least one software component;
to generate an upgrade score for the at least one software component based on at least a portion of one or more of the obtained vulnerability information and the obtained license information;
to determine, by the at least one processing device, whether to upgrade the at least one software component to the updated version based at least in part on the upgrade score; and
to initiate one or more automated actions based at least in part on a result of the determining.

10. The non-transitory processor-readable storage medium of claim 9, wherein a plurality of security scanners generates the vulnerability information and wherein the plurality of security scanners comprises at least two distinct security scanner tools operating on separate processing platforms.

11. The non-transitory processor-readable storage medium of claim 9, wherein the one or more automated actions comprise at least one of:
updating the at least one software component to the updated version;
deploying the updated version of the at least one software component to one or more computing environments; and
providing the upgrade score and information related to the at least one software component to an interactive dashboard.

12. The non-transitory processor-readable storage medium of claim 9, wherein the vulnerability information is obtained for a plurality of versions of the at least one software component and comprises a respective vulnerability count for each of two or more vulnerability severity levels.

13. The non-transitory processor-readable storage medium of claim 12, wherein the generating the upgrade score comprises comparing the vulnerability information across multiple previous versions of the at least one software component.

14. The non-transitory processor-readable storage medium of claim 12, wherein the upgrade score is further based on version information obtained from one or more online sources, wherein the version information comprises:
release dates corresponding to respective ones of the plurality of versions of the at least one software component;
release notes corresponding to respective ones of the plurality of versions of the at least one software component; and
issue tracking information corresponding to respective ones of the plurality of versions of the at least one software component.

15. The non-transitory processor-readable storage medium of claim 9, wherein the program code, when executed by the at least one processing device, further causes the at least one processing device:
to perform one or more of unit testing and integration testing for the updated version of the at least one software component; and
to adjust the upgrade score based at least in part on a result of the one or more of the unit testing and the integration testing.

16. An apparatus comprising:
at least one processing device comprising a processor coupled to a memory;
the at least one processing device being configured:
to identify, by the at least one processing device, a release of an updated version of at least one software component of a software project;
to obtain one or more of: vulnerability information for the at least one software component and license information associated with the at least one software component;
to generate an upgrade score for the at least one software component based on at least a portion of one or more of the obtained vulnerability information and the obtained license information;
to determine, by the at least one processing device, whether to upgrade the at least one software component to the updated version based at least in part on the upgrade score; and
to initiate one or more automated actions based at least in part on a result of the determining.

17. The apparatus of claim 16, wherein a plurality of security scanners generates the vulnerability information and wherein the plurality of security scanners comprises at least two distinct security scanner tools operating on separate processing platforms.

18. The apparatus of claim 16, wherein the one or more automated actions comprise at least one of:
updating the at least one software component to the updated version;
deploying the updated version of the at least one software component to one or more computing environments; and
providing the upgrade score and information related to the at least one software component to an interactive dashboard.

19. The apparatus of claim 16, wherein the vulnerability information is obtained for a plurality of versions of the at least one software component and comprises a respective vulnerability count for each of two or more vulnerability severity levels.

20. The apparatus of claim 19, wherein the generating the upgrade score comprises comparing the vulnerability information across multiple previous versions of the at least one software component.
